(19) United States
(12) Patent Application Publication
(10) Pub. No.: US 2009/0054076 A1
(43) Pub. Date: Feb. 26, 2009

(54) Method and Device for Locating a Terminal in a Wireless Local Area Network

(76) Inventors: Frederic Evennou, Grenoble (FR); Francois Marx, Paris (FR); Jean-Paul Laval, Le Versoud (FR)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 11/921,389

(22) PCT Filed: May 29, 2006
(86) PCT No.: PCT/FR2006/001214

§ 371 Date: Nov. 30, 2007

(30) Foreign Application Priority Data
May 31, 2005 (FR) 0505509

(51) Int. Cl. H04W 24/00

(52) U.S. Cl. 455/456.1

(57) ABSTRACT

A method for locating a terminal in an environment equipped with a set of telecommunication terminal devices of a local wireless network, using a reference database previously stored with a plurality of vectors respectively associated with a plurality of different points of said environment, wherein each vector has, as components, values of powers received from the various terminal devices by a terminal positioned at the point associated with this vector, wherein the terminal includes inertial measurement means, comprising measuring, from the terminal, the powers received from at least some of the telecommunication terminal devices; delivering, as a position result, an identification of the point at which the terminal is located, which point is defined as that where the associated reference vector is closest to the vector formed by the powers measured from the terminal; filtering the position result delivered, and taking into account inertial navigation data provided by the inertial measurement means; and correcting an inertial drift of the inertial measurement means, taking into account a global trajectory of the terminal given by said means for filtering the position result delivered.

### RELATED APPLICATIONS

This application claims priority to PCT Application No. PCT/FR2006/001214 filed May 29, 2006, and French Application No. 0505509 filed May 31, 2005, the disclosures of which are hereby incorporated by reference in their entireties.

### FIELD OF INVENTION

This invention relates to the locating of telecommunication terminals in a local wireless Wi-Fi-type network. It relates more specifically to the locating of terminals in closed buildings, so as to be capable of locating a carrier of the terminal, in wireless telecommunications or broadcasting networks.

Conventionally, to locate a person or a terminal in a given geographic area, a GPS positioning system (“Global Positioning System”) or the GSM system (“Global System for Mobile Communication”) is generally used. However, these techniques are difficult to use in an enclosed area, due to their poor performance in indoor environments. Indeed, in the case of the GPS, it is difficult to receive a correct signal, and in the case of the GSM, the precision is not sufficient, and must be, in the application envisaged, on the order of several meters.

The prior art, in particular patent application FR0401759 of the applicant, discloses methods for locating a terminal in a closed environment (building) equipped with telecommunication terminal devices for a local Wi-Fi-type wireless network.

Such methods use, from a terminal, the transmission power measurements of telecommunication terminal devices of a local wireless network, compare these powers received from each terminal device with power values stored in a database, and which each correspond to a position of the terminal with respect to the terminal devices, and filter the result so as to reduce the effect of the noise inherent to the measurements, wherein the filtering step uses a particle filter or a Kalman filter.

The benefit of filtering is to limit the effect of power fluctuations, which cause incoherent positions or movements.

During the particle filtering, all of the possible positions of the terminal are modeled by particles (a particle being a position that the mobile terminal seeking to be located can occupy) each assigned a presence probability, the new possible position of each particle is determined a priori, and a weight assigned to the particle is corrected on the basis of the new power measurements.

The use of advanced filtering techniques such as these makes it possible to obtain a closed environment (indoor) location to within two meters for a mobile object.

However, certain situations can nevertheless lead to uncertainties, in particular when a plurality of choices are presented for the filter. These situations relate, for example, to the choice of the room that the user, i.e. the carrier of the terminal, has entered, when, moving through a long corridor, two doors are opposite one another. This therefore raises a possible ambiguity, and it is removed only after a certain time (inertia of the filter).

In addition, the simple use of radio technology, as first locating means, does not make it possible to instantaneously determine whether or not the user is moving.

Finally, the method above requires the constitution of a database (for example, correspondence between the position of the terminal and the power received from the terminal devices) before any locating operation.

This invention aims to overcome these disadvantages by proposing a solution combining data from two different locating means.

### SUMMARY OF THE INVENTION

The present invention aims to remove the ambiguities of the results obtained with first locating means using at least one signal coming from at least one terminal device of a wireless network, by using at least one signal coming from second locating means.

The invention relates in particular to a method for locating a terminal in an environment equipped with a set of telecommunication terminal devices of a local wireless network, wherein the terminal includes inertial measurement means, which method includes the steps consisting of:
storing, in a preliminary step, in a reference database, a plurality of vectors respectively associated with a plurality of different points of said environment, wherein each vector has, as components, values of powers received from the various terminal devices by a terminal positioned at the point associated with this vector,
measuring, from the terminal, the powers received from at least some of the telecommunication terminal devices,
delivering as a position result an identification of the point at which the terminal is located, which point is defined as that where the associated reference vector is closest to the vector formed by the powers measured from the terminal.

The method of the invention is essentially characterized in that it includes, in addition,
a filtering step consisting of filtering, by filtering means, the position result delivered, also taking into account inertial navigation data provided by the inertial measurement means, and
a correction step consisting of correcting an inertial drift of the inertial measurement means, taking into account a global trajectory of the terminal given by said means for filtering the position result delivered.

The synergistic effect provided by the use of the global trajectory in the correction of the signals provided by the second locating means leads to an improvement in the locating precision.

It can thus be stated that first locating means use the radio positioning by at least one telecommunications or broadcasting terminal device. And a first signal comes in particular from the measurement of power from at least one terminal device of a wireless network.

And second locating means use the positioning by inertial measuring means, for example, an inertial system including inertial navigation sensors (INS).

In some cases, the data provided by the second locating means (the inertial data) is subjected to drifts due to the noise and to the successive integrations. Means for correcting the signal provided by the second locating means, in particular a Kalman filter, can be envisaged in order to reduce the effect of this measurement noise.

One embodiment provides a step of filtering inertial navigation data consisting of filtering at least some of the inertial navigation data from the inertial measurement means.

The determination of the position can be made by an object position probability distribution, based on the first and second signals received respectively from the first and second locating means, for example, a particle filter.

For better comprehension, “particle filter” in this application means any filter of which the function is to smooth over locating errors according to data of various types. The distribution obtained by this type of filter can also be obtained, for example, by a Monte Carlo filter.

In one embodiment, in the step of filtering the delivered position result, a possible position of the terminal is modeled by a set of particles, with a presence probability being assigned to each of said particles.

Preferably, in the step of filtering the delivered position result, parameters are modeled into probability densities so as to determine the presence probabilities to be assigned to the particles, with said parameters including at least one of the data items of the group comprising the power data received, inertial navigation data and data relating to the environment of the terminal.

In one embodiment, to determine the position of the terminal, a step of a priori determination of the position of the particles is provided, at least taking into account, for a particle, its last known position, a velocity of the particle and a data item representative of a state of the terminal, indicating whether or not it is moving, obtained on the basis of the data provided by the inertial measurement means.

Preferably, to determine the position of the terminal, a step of a posteriori determination of the position of the particles is provided, taking into account new measurements of powers received from at least some of the telecommunication terminal devices.

In one embodiment, the particle (or “bootstrap”) filter integrates the inertial navigation data from the inertial system of which at least some is corrected by a Kalman filter.

With this combination, the positioning of the terminal is more precise.

In another embodiment, the determination of the position is dependent on a known prior position.

By this synergistic effect provided by the use of a known prior position in addition to signals provided by the first and second locating means in the determination of the new position, the locating precision is also improved.

Advantageously, the known prior position is the last position obtained. Alternatively, it corresponds to the last position obtained of which the probability is greater than a predetermined threshold, so that the position calculations are done on the basis of a position obtained with greater precision.

In a preferred embodiment, the reaching of the threshold value is restricted to a given time period. For example, a thresholding system is established in order to verify whether or not the mobile device is moving: if during a period of several milliseconds (depending on the INS data refresh rate), the signal coming from acceleration sensors has passed the threshold, the object is considered to be moving.

In one embodiment, the step of determining the position of the object is dependent on the measurement of the angular velocity of the object provided by the second locating means.

As an alternative or a complement, the step of determining the position of the object is dependent on a signal, provided by the second locating means, making it possible to obtain an indication of the position on the vertical axis.

The invention also presents, at the level of the inertial measurement means, for example, an inertial system, and sensors delivering inertial data (angular velocity, movement of the terminal with respect to the magnetic north, acceleration of the terminal in at least one direction in space, the atmospheric pressure (altitude), the number of steps taken by a carrier of the terminal, etc.).

Thus, taking into consideration the movements of the user by means of inertial navigation sensors and the radio locating navigation technique combined with a filter, for example, a particle filter, it is possible to obtain a movement that is more fluid and much more sensitive to changes in the state of the user (start/stop, movement in straight line/turning).

Finally by taking into account the structure of the building, all unrealistic movements, such as passing through a wall, are eliminated.

In one embodiment, the invention also includes steps of updating and correcting the measurement of the angular velocity of the terminal, in which the indications coming from the global trajectory of the terminal given by the particle filter are used to correct the inertial drift. The mathematical tool used to carry out these correction and updating steps can be a Kalman filter applied to this data item (angle by which the terminal has turned).

Thus, the angle returned in this step can be reused by the particle filter to more precisely guide the particles.

The telecommunication or broadcasting terminal devices of a local wireless network are terminal devices for example of the Wi-Fi, Bluetooth or Zigbee type, and so on.

The determination of the position can be made on the basis of signals coming from one or more terminal devices. The increase in the number of terminal devices used makes it possible to remove position ambiguities, but the decrease in the number of terminal devices used makes it possible to provide a wider locating area. In one embodiment, the invention can be adapted to the number of terminal devices available so as to offer a large area of coverage while providing a gradation in the precision, up to a very high precision in certain portions of this coverage area.

The invention also relates to a terminal configured so as to be located in an environment equipped with a set of telecommunication terminal devices of a local wireless network, with the terminal including at least:
inertial measurement means,
means for measuring, from the terminal, the powers received from at least some of the telecommunication terminal devices,
means for delivering, as a position result, an identification of the point at which the terminal is located, defined as that where an associated reference vector is closest to the vector formed by the powers measured from the terminal, with said reference vector being extracted from a reference database containing a plurality of reference vectors respectively associated with a plurality of different points of said environment, with each vector having, as components, values of powers received from the various terminal devices by a terminal positioned at the point associated with this vector.

According to one embodiment the invention, the terminal is essentially characterized in that it also includes:
filtering means arranged to filter the delivered position result, also taking into account inertial navigation data from the inertial measurement means, and
correction means arranged to correct an inertial drift of the inertial measurement means, taking into account a global trajectory of the terminal given by said means for filtering the delivered position result.

In one embodiment, the terminal includes means for communication with a locating server.

Advantageously, the terminal includes means for filtering at least some of the inertial navigation data from the inertial measurement means.

In one embodiment, the terminal is also equipped with means for storing said reference database.

In one embodiment, the terminal includes at least inertial measurement means, for example an inertial system, and means for communication with a locating server if the locating operation is not performed on the terminal (for example if the calculation resources of the terminal are insufficient).

According to the preferred embodiment, the inertial system contains at least one of the devices making it possible, for example, to measure the angular velocity, the angular direction of the movement of the terminal with respect to the magnetic north, the vertical acceleration (associated with walking), the atmospheric pressure (altitude), and to count the number of steps taken by a carrier of the terminal.

The invention also relates to a locating server configured to locate, in an environment equipped with a set of telecommunication terminal devices of a local wireless network, a terminal at least equipped with inertial measurement means, which server includes at least:
means for communicating with the terminal,
means for storing, in a reference database, a plurality of vectors respectively associated with a plurality of different points of said environment, wherein each vector has, as components, values of powers received from the various terminal devices by a terminal positioned at the point associated with this vector.
means for delivering, as the position result, an identification of the point at which the terminal is located, which point is defined as that where the associated reference vector is closest, in the sense of Euclidean distance, to the vector formed by the powers measured from the terminal.

According to the invention, the server is essentially characterized in that it also includes:
filtering means arranged to filter the delivered position result, also taking into account inertial navigation data from the inertial system, and
means for ordering a correction of an inertial drift of the inertial measurement means of the terminal, taking into account a global trajectory of the terminal given by said means for filtering the delivered position result.

It is possible for this server to provide only the data needed by the client that has been recorded (plan data of the area he/she is entering), or to perform only the necessary processing operations making it possible to locate the mobile device.

The server includes, in particular, means for communication with the terminal, and can also possess combined filtering means, for example Kalman filter/particle filter.

The invention also relates to a system for locating a terminal in an environment equipped with a set of telecommunication terminal devices of a local wireless network, which system includes at least:
a terminal at least equipped with means for communicating with a locating server, and an inertial system delivering inertial navigation data,
a locating server equipped with means for communication with the terminal, in which system:
a plurality of vectors, respectively associated with a plurality of different points of said environment, having previously been stored in a reference database; each vector has, as components, values of powers received from the various terminal devices by a terminal positioned at the point associated with this vector,
the power received from at least some of the telecommunication terminal devices is measured from the terminal,
an identification of the point at which the terminal is located is delivered as a position result, with this point being defined as that where an associated reference vector is closest, in the sense of Euclidean distance, to the vector formed by the powers measured from the terminal.
   The system is essentially characterized in that:
filtering means, in particular using a Kalman filter, filter at least some of the inertial navigation data from the inertial system,
correction means correct an inertial drift of the inertial measurement means of the terminal, taking into account a global trajectory of the terminal given by said means for filtering the delivered position result.

Preferably, the system is such that the telecommunication terminal devices of a local wireless network are terminal devices of the Wi-Fi, Wimax, Bluetooth or Zigbee type.

Another object of the invention relates to a computer program for a terminal, for locating said terminal in an environment equipped with a set of telecommunication terminal devices of a local wireless network, which program includes program instructions for ordering the execution by said terminal, when the program is executed by it, of steps at least consisting of:
measuring, from the terminal, the powers received from at least some of the telecommunication terminal devices,
delivering, as a position result, an identification of the point at which the terminal is located, which point is defined as that where the associated reference vector is closest to the vector formed by the powers measured from the terminal, wherein said reference vector is extracted from a reference database containing a plurality of vectors respectively associated with a plurality of different points of said environment, with each vector having, as components, values of powers received from the various terminal devices by a terminal positioned at the point associated with this vector,
filtering, with the assistance of filtering means, the delivered position result, also taking into account inertial navigation data provided by the inertial measurement means, and
correcting an inertial drift of the inertial measurement means, taking into account a global trajectory of the terminal given by said means for filtering the delivered position result.

Finally, the invention relates to a computer-readable program support on which the aforementioned program is saved.

Regardless of its object (method, device, terminal, server or system), the invention can use a locating database for calculating the position of the carrier by the first locating means. This database can be located on the terminal or remotely available on the server. With the second locating means, the invention also makes it possible, where appropriate, to construct or refine the locating database.

### BRIEF DESCRIPTION OF THE DRAWINGS

Other features and advantages of this invention will become clearer upon reading the following description, given by way of an illustrative and non-limiting example, in reference to the appended figures, in which:

FIG. 1 shows a diagrammatic view of a closed building (B) in which a terminal is to be located,

FIG. 2 shows a diagram of the operation of the method according to the invention.

### DETAILED DESCRIPTION OF THE DRAWINGS

The invention relates to locating techniques using short-range radio technology for locating a user (person or hardware) having a radio receiver (terminal), combined with techniques making it possible to improve the precision of the locating operation by using, preferably, filters for reducing the noise on the measurements (Wi-Fi and INS).

The additional data provided on the user's behavior by means of the inertial navigation sensors, integrated in the terminal, makes it possible to increase the locating precision, and to remove any ambiguity that may be related to changes in direction, for example.

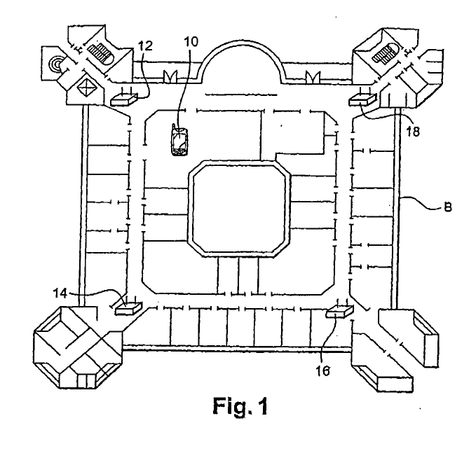

The invention also relates in particular to a method for locating a terminal 10 in an environment B (see FIG. 1). The environment B is equipped with a set of telecommunication or broadcasting terminal devices 12, 14, 16, 18 of a local wireless network. The terminal includes inertial measurement means, for example an inertial system, including at least one sensor, delivering navigation data (INS).

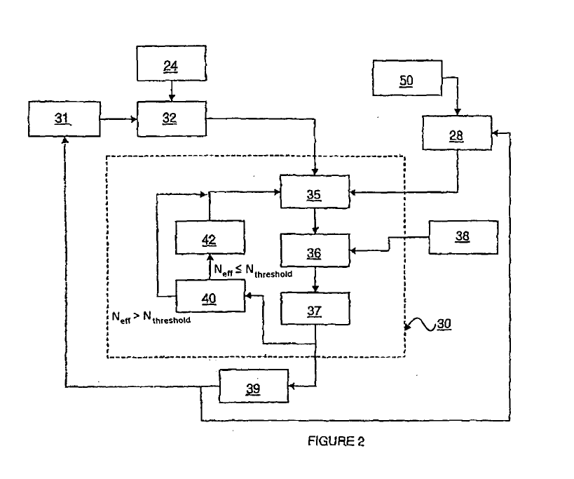

As shown in FIG. 2, the method includes, in a particular embodiment, a preliminary step consisting of storing, in a reference database 24, a plurality of vectors, electronically characterizing certain positions of the building, respectively associated with a plurality of different points of said environment B.

Each vector has, as components, either values of powers received from the various terminal devices by a terminal positioned at the point associated with this vector, or the distribution of power of the signals received for each of the terminal devices detected.

Conventionally, the powers received 31 from at least some of the telecommunication terminal devices 12, 14, 16, 18 are then measured from the terminal 10, and, as the position result 32, an identification is delivered showing the point Z at which the terminal is located according to the Wi-Fi measurement performed and the available database.

This point is defined as that where an associated reference vector is closest, in the sense of the Euclidean distance, to the vector formed by the powers measured from the terminal.

Typically, point Z is sought in the building space and the database such that:

Z=arg min Σ(Pterminalᵢ(x,y)−Pterminalᵢ(received))²zε(x,y) of the database all terminal devices

Z therefore corresponds to the point in the database grid where the terminal is closest.

In one embodiment of the invention, the method also includes the steps consisting of:
filtering, by filtering means using, for example, a Kalman filter 28, at least some of the inertial navigation data from the inertial system 50, if necessary, and
filtering, by filtering means using, for example, a particle filter 30, the position result, also integrating the inertial navigation data from the inertial system of which at least some is corrected by the Kalman filter 28 (if necessary), and data from the Wi-Fi locating operation.

The method preferably also includes, at the level of the inertial system, at least one of the steps consisting of generating a signal of which the value corresponds to the measurement of:
the angular velocity of the terminal,
the direction of movement of the terminal with respect to magnetic north,
the acceleration of the terminal in at least one direction in space,
the atmospheric pressure, or altitude,
the number of steps taken by a carrier of the terminal.

Thus, with the filters, the combination of the location obtained by the radio system and that provided by the inertial navigation sensors makes it possible to improve the locating precision to the order of one meter.

In one embodiment, a Kalman filter can in particular reduce the drift of inertial navigation data by taking into account data from the locating operation by the first locating means, for example a Wi-Fi system, within a navigation system, and this inertial navigation data, from the second locating means, can be reinserted into a filter, for example a particle filter, so as to refine the locating operation by a radio system.

The insertion of inertial navigation data into the filter system makes it possible to refine the Wi-Fi locating operation and to remove any ambiguity that may exist in certain situations (choice of the room that the user has entered when two doors are located opposite one another, for example).

In addition, this invention makes it possible to increase the locating area. Indeed, it is possible for certain areas not to be covered by the radio system; in this case, the inertial sensors will continue to provide information on the behavior of the carrier of the terminal. This data will result in an estimation of the terminal position in spite of a failure of the radio system (navigation by estimate). When the radio locating is again available, the positioning drifts due to the noises of the various sensors are corrected.

Thus, this invention also makes it possible to assist in the construction, i.e. to construct or refine, the database used by the radio locating system (automatic construction of the database) since the system for navigation by estimate provides data on the user's position in the environment at any time, within a margin of error due to the drift caused by the noise tainting the measurements.

The step consisting of generating a signal of which the value corresponds to the measurement of the angular velocity of the terminal can be performed by a gyroscope.

A gyroscope delivers the instantaneous angular velocity of the sensor. Thus, to determine the angle θ by which the terminal has turned, it is necessary to integrate this value over time:

$${θ}_{1} = {\sum }_{k = 0}^{t} ( {\dot{θ}}_{k} - {\dot{θ}}_{k - 1} ) * Δ {t}_{k}$$

It is thus possible to continuously determine the angle by which the sensor has turned from the time it has been turned on. However, these measurements are noisy (noise due to the sensor), which introduces a certain drift over time, due to the integration (discrete summation). After a certain operation time, which is a few minutes, the data coming from this sensor is no longer correct. It is therefore necessary to correct this data.

In one embodiment, the method therefore includes steps of updating and correcting the measurement of the angular velocity of the terminal, in which the indications from the global trajectory of the terminal given by the particle filter are used to correct the inertial drift, and a Kalman filtering operation is performed in order to monitor the change in the value of the angle by which the terminal has turned, in which the updating and correction steps are the following:

θₖ⁻=θₖ₋₁−θₖ*Δt

Pₖ⁻=Q+Pₖ₋₁

Kₖ=Pₖ⁻*[Pₖ⁻+R]⁻¹

θₖ=θₖ⁻+Kₖ{[θ_{trajectory}−θₖ⁻]−Ent[0,5+(θ_{trajectory}−θₖ⁻)/II]*II}

Pₖ=(1−K)*Pₖ⁻

where
θ_{trajectory} is the angle calculated for the trajectory that is returned by the measurement of powers received,
θₖ is the angle of the device making it possible to measure the angular velocity after correction,
θₖ⁻ is the raw angle of the device making it possible to measure the angular speed without correction,
Ent[ ] is the entire portion,
K is the Kalman gain,
Q is the covariance of the noise tainting the estimation process a priori,
R is the covariance of the noise tainting the measurements.

Indeed, the indications from the global trajectory of the mobile device (given by the particle filter, and taking into account the Wi-Fi radio measurement) must be used to correct the inertial drift. Thus a Kalman filtering operation is performed in order to monitor the change in this angle value and thus be more robust with respect to the drifts of the sensor.

The particle filter is a filter that makes it possible to integrate various different types of data, namely powers data (or position data predicted by the use of a database), a plan of the environment in which the mobile device is immersed, inertial navigation data (velocity and acceleration of the mobile device, direction of movement with a compass or a gyroscope, etc.). This is made possible by the fact that the filter uses probability densities that model various different parameters.

The particle filtering is performed by using a set of particles that model a possible position of the terminal, and each of these particles is assigned a presence weight (or probability).

This takes place (cf. FIG. 2) in two steps: a first step 35 of determination a priori and a second step 37 of determination a posteriori.

In one embodiment, the particle filter can be defined according to the following two equations:

Xₖ=fₖ(Xₖ₋₁,υₖ₋₁)

Zₖ=hₖ(Xₖ,ηₖ)

where Zₖ is the position corresponding to the new measurement of powers received, extracted from the database by “fingerprinting” (correspondence between level of powers received and position of the terminal), and Xₖ is a vector containing the position and the velocity of the terminal.
υₖ₋₁ and ηₖ designate two random noises, possibly Gaussian.

fₖ and hₖ designate two functions, possibly non-linear, in which fₖ makes it possible to determine the position of the terminal a priori on the basis of the history of previous positions and hₖ makes it possible to relate the a priori position with all of the measurements available.

In addition, the weight wₖ₊₁ⁱ of a particle i is related to the weight wₖⁱ of this particle at the previous time k and is defined according to the following relation:

$${w}_{k + 1}^{i} ∝ {w}_{k}^{i} * \frac{Pr [ {Z}_{k} \vert {x}_{k}^{i} ] Pr [ {x}_{k}^{i} \vert {x}_{k - 1}^{i} ]}{q ( {x}_{k}^{i} \vert {x}_{k - 1}^{i} , {z}_{k} )}$$

$$in which \text{:}$$

$$Pr [ {x}_{k}^{i} \vert {x}_{k - 1}^{i} ] , Pr [ {x}_{k}^{i} \vert {x}_{k - 1}^{i} ] and q ( {x}_{k}^{i} \vert {x}_{k - 1}^{i} , {z}_{k} )$$

respectively designate the a priori probability of the presence of a particle, the a posteriori probability of the presence calculated, and an importance function penalizing improbable movements, so as to reduce the effect of the random selection performed in the a priori step.

For the a priori determination step, the a priori position of each particle is determined only by its last known position. Thus, to have the particles randomly explore the building, a noise with a power carefully determined so that the particles move between two successive measurements is used. For this, in one embodiment, the step of determining the position uses the movement equation based on:
at least one prior position of the known object,
and at least one signal provided by the second locating means.

In a particular embodiment, the law of equation of motion is used, where each particle has, as parameters, its position (x, y), its speed (Vx, Vy) and its weight. Thus, for a particle:

$$[ \begin{matrix}{x}_{k + 1} \\ {y}_{k + 1} \\ {V}_{xk + 1} \\ {V}_{yk + 1}\end{matrix} ] = [ \begin{matrix}1 & 0 & D * {T}_{s} & 0 \\ 0 & 1 & 0 & D * {T}_{s} \\ 0 & 0 & cos ( {O}_{gyro} ) & 0 \\ 0 & 0 & 0 & sin ( {O}_{gyro} )\end{matrix} ] [ \begin{matrix}{x}_{k} \\ {y}_{k} \\ {V}_{xk} \\ {V}_{yk}\end{matrix} ] + [ \begin{matrix}\frac{{T}_{s}^{2}}{2} & 0 & 0 & 0 \\ 0 & \frac{{T}_{s}^{2}}{2} & 0 & 0 \\ 0 & 0 & {T}_{s} & 0 \\ 0 & 0 & 0 & {\breve{T}}_{s}\end{matrix} ] [ \begin{matrix}{v}_{xk} \\ {v}_{yk} \\ {v}_{xk} \\ {v}_{yk}\end{matrix} ]$$

where
Xₖ₊₁ and yₖ₊₁ designate the coordinates of the particle determined a priori,
Xₖ and yₖ designate the coordinates of the particle determined on the basis of a previous power measurement,
Vxₖ₊₁ and Vyₖ₊₁ designate the speed of the particle in directions x and y,
υₓₖ and υ_{yk} designate a noise in directions x and y indicating the movement of the particle between two consecutive measurements,
Dε{0,1} represents a state indicating whether or not the terminal is moving. Typically, if the terminal is moving, the new position occupied by each of the particles must be different from the previous one; otherwise, it is not necessary for the particles to move. This data is obtained, for example, by the data returned by the accelerometers;
Ts represents the time that has passed between two successive Wi-Fi measurements,
θ_{gyro} is the angle returned by the signal of which the value corresponds to the measurement of the angular velocity of the terminal,
after correction by a Kalman filter (from the inertial navigation system).

For the a posteriori determination step, it is necessary to take into account the new measurement of powers received and, if available, data on the structure of the building. It is thus possible to take into account walls and to penalize, and even eliminate, the particles that have passed through a wall.

In one embodiment, the new position Zₖ determined by the set of powers received is entered into the particle filter by the following probability density:

$$Pr [ {Z}_{k} \vert {x}_{k}^{l} ] = exp [ \frac{{( {X}_{{z}_{k}} - {X}_{{l}_{{X}_{k}}} )}^{2} + {( {Y}_{{Z}_{k}} - {Y}_{{t}_{{X}_{k}}} )}^{2 δ}}{{σ}^{2}} ]$$

where this probability density is, preferably, a Gaussian law centered on the position from the measurement, with a standard deviation chosen so as to represent a realistic distance that the terminal can cover between two successive measurements.

In addition, the new particle weight is determined according to the following relation:

wₖ₊₁ⁱ∝wₖⁱ*Pr[_{Z}_{ₖ}|_{X}_{ₖ}ⁱ]*Pr[_{X}_{ₖ}ⁱ|_{X}_{_{k−1}}ⁱ]

A step of normalizing the weights can then be performed so as to obtain the following probability density:

$${w}_{k}^{i} = \frac{{w}_{k}^{d 0}}{{\sum }_{k = 1}^{{N}_{s}} {w}_{k}^{i}}$$

where Ns is the total number of particles that explore the environment.

Still in reference to FIG. 2, step 36 corresponds to the search for particles that have passed through a wall using the building plan provided in 38. Typically, particles that have passed through a wall are sought using a database showing a view of the building or, generally, in which unlikely movement data is stored.

On each receipt of a new measurement, the filter changes, and the weight of the particles changes. There comes a time when certain particles, randomly exploring the environment, or having passed through a wall, will obtain an extremely low weight, even zero, while others, which will have successfully monitored the change in movement of the mobile device, will have a significant weight. This filter decay can continue until only a single particle survives, which is one of the disadvantages of the filter.

To avoid such a decay, in one embodiment, a re-sampling step is necessary and makes it possible to bring the particles that have a very low weight (presence of the terminal in this area is very unlikely) to the area in which the mobile device is likely located, i.e. around particles with a significant weight.

The re-sampling step 42 takes place when the number of particles N_{eff} in force is lower than a threshold value N_{threshold}, with this test 40 being performed according to the following relation:

$${N}_{eff} = \frac{1}{{\sum }_{t = 1}^{{N}_{s}} {( {w}_{k}^{i} )}^{2}} \leq {N}_{threshold}$$

where, preferably, N_{threshold}=Ns/100.

The re-sampling step 42 is intended to reintroduce a certain diversity among the particles, and includes the following steps:

A) calculating the covariance matrix Sₖ of the particles

{Xₖⁱ,Wₖⁱ}ₜ₌₁^{Ns}

B) calculating Dₖ such that Sₖ=DₖDₖ^{T}

C) re-sampling with the following logic steps:

a. resetting the cumulative distribution function vector CDF such that CDF (1)=0,

b. constructing CDF such that

CDF(i)=CDF(i−1)+wₖⁱaveci={2:Nₛ},

c. resetting i to 1,

d. randomly selecting a value u(1) in a uniform distribution U[0,Nₛ⁻¹]₁,

e. check CDF: j={1:Nₛ}

i. u(j)=u(l)+(j−1)/Ns

ii. if u(j)>CDF(i) then i=i+1

iii. xₖⁱ=xₖⁱet wₖ^{j}=Nₓ⁻¹

f. check the particles: i={1:N_{s }}

i. randomly select a noise ε¹ in a kernel (Gaussian, Epanechnikovk, etc.),

ii. update the new position of the particles such that:

xₖⁱ=xₖⁱ+hₒₚₜDₖδⁱ

This last noise making it possible to reintroduce a new diversity around advantageous positions, where, in the case of a Gaussian kernel, the constant is expressed as follows:

$${h}_{opt} = Λ ( K ) {N}_{S} exp ( \frac{1}{{n}_{x} + 4} ) and A ( K ) = {( \frac{4}{{n}_{x} + 2} )}^{\frac{{1}^{20}}{{n}_{x} + 4}}$$

where nₓ designates the dimension of the space in which one is located. Preferably, in this case, nₓ=4.

The method updates the new weight of each particle and determines the new position in step 39. Preferably, the position returned by the filter is the barycenter of the coordinates of all of the particles.

In another embodiment, the particles may be required to move on the edges of a Voronoi graph (model of the building (B) developed on the basis of a Voronoi diagram of the building). The model includes a set of possible paths for the particles in which they are authorized to move.

In this case, it is entirely possible to combine the data coming from the inertial navigation sensors with the particle filter associated with this technique. In this configuration, the angle returned by the gyroscope makes it possible to choose the next arc on which the particles must move when they change arcs.

In the prior art techniques, a random choice of the arc was used, with a preference for arcs located at Pi radians from the arc where they were located (forward movement situation). In addition, this choice respects the true behavior of the user, which was not possible with the previous system.

As for the traditional particle filter, it is possible to immobilize the particles if the accelerometers indicate that the terminal is not moving.

Thus, the determination of the position can be dependent on the state of the object, which state is provided by the second locating means.

The invention also relates to a locating device. This device includes means suitable for triggering the implementation of a position determination on the basis of signals coming from first and second different locating means. The signal provided by the first means comes from at least one wireless network terminal device.

In one embodiment, the device includes first locating means.

Alternatively, it includes means for receiving signals from these first locating means.

In another embodiment, the device includes the second locating means.

Alternatively, it includes means for receiving signals from the second locating means.

In another embodiment, the device includes position determination means.

Alternatively, it includes means for communicating with position determination means, which communication means make it possible to receive the position determined by the position determination means.

The device according to the invention can implement any one of the alternative combinations above.

The invention also relates to a terminal 10 configured so as to be located in an environment B equipped with a set of telecommunication terminal devices 12, 14, 16, 18 of a local wireless network. The terminal includes at least:
means suitable for triggering the implementation of a position determination on the basis of first and second signals respectively coming from first and second different locating means, wherein said first signal is provided by the first locating means, and comprises at least one measurement of the powers received from the terminal, coming from at least one wireless network terminal device,
and means for delivering the determined position.

In an embodiment, the second locating means are inertial measurement means, for example an inertial system.

It can include means for storing, in a preliminary stage, in a reference database 24, a plurality of vectors respectively associated with a plurality of different points of said environment B, wherein each vector has, as components, values of power received from the various terminal devices by a terminal positioned at the point associated with this vector, or elements characterizing the probability distribution associated with the powers received in this position.

The terminal also includes means for measuring, from the terminal, the powers received from at least some of the telecommunication terminal devices 12, 14, 16, 18, and means for delivering, as a position result, an identification of the point at which the terminal is located.

This point is defined as that where the associated reference vector is closest, in the sense of Euclidean distance, to the vector formed by the powers measured from the terminal with those contained in the database.

According to the invention, the terminal also includes means for communicating with a locating server in order to obtain building mapping data and if these equipment resources are too limited to perform the processing operations necessary for the locating operation, as well as filtering means.

These filtering means include means for filtering, with a Kalman filter 28, at least some of the inertial navigation data from the inertial system, and means for filtering, with a particle filter 30, the position result by integrating the Wi-Fi measurements, as well as the inertial navigation data from the inertial system, of which at least some is corrected by the Kalman filter.

According to the aforementioned embodiment, the inertial system of the terminal contains at least one of the following devices (sensors) making it possible to:
measure the angular velocity, in particular a gyroscope,
measure the angular direction of the movement of the terminal with respect to the magnetic north, in particular a magnetometer,
measure the acceleration according to at least one direction in space, in particular an accelerometer,
measure the atmospheric pressure, in particular a barometric sensor,
count the number of steps taken by a carrier of the terminal, in particular a pedometer.

The data from the various sensors is collected and formatted by a microcontroller. The frame thus constituted is sent to the equipment (PDA, laptop PC, etc.) via a RS232 connection or a wireless connection (Bluetooth, for example) or other connection, so as to eliminate the constraints of wiring between the mobile terminal and the inertial navigation sensors.

The accelerometer sensors make it possible to determine whether or not the user is moving, and thus to take this data into account in the particle filter used in radio locating operations.

The counting of the number of steps taken by the user is also possible. The evaluation of the distance is then more complex to implement, and requires a certain calibration of the sensor (distance covered between two steps) in order to lead to an estimation of the distance covered. This calibration can be performed over time by radio measurements that make it possible to determine the user's position. Thus, a system for self-calibration of the accelerometer sensor is possible.

The barometric probe makes it possible to determine the altitude at which the user is located. It is thus possible to detect when the user moves from one floor to another, for example (by stairways, or by an elevator). This type of information makes it possible to extend the radio locating technique (Wi-Fi) by using the three-dimensional building plan. It is thus possible to give the filter the correct floor plan in which the mobile device is moving.

The barometric probe also makes it possible to detect less significant variations in pressure; it is possible to detect the station in a sitting or standing position. To eliminate the noise associated with the sensor, a simple low-pass filtering operation can be performed on the pressure, for example:

Pₜ=0.1*Pₜ^{sensor}+0.9*Pₜ₋₁

It is then possible to convert this atmospheric pressure into an altitude variation because the pressure varies by one mbar every 10 m. Thus, by measuring the pressure variation overtime, it is possible to determine whether the carrier of the terminal has gone up or down.

Another object of the invention is a locating server configured to locate a terminal 10 in an environment B equipped with a set of telecommunication terminal devices 12, 14, 16, 18 of a local wireless network. The terminal is at least equipped with an inertial system and means for measuring, from the terminal, the powers received from at least some of the telecommunication terminal devices 12, 14, 16, 18, and the server includes at least means for communication with the terminal 10.

This server is not obligatory in the sense that, if the terminal has all of the data (for example, power/position database, building plan, etc.) and its computing resources are sufficient, the terminal can determine its position, without communicating with a server. If one of the two previous conditions is not satisfied, then it is necessary to have recourse to such a server.

Conventionally, in the case of a remote architecture, the server includes means for storing, in a preliminary step, in a reference database 24, a plurality of vectors respectively associated with a plurality of different points of said environment B.

Each vector has, as components, values of powers received from the various terminal devices by a terminal positioned at the point associated with this vector.

In addition, the server includes means for delivering, as a position result, the one taking into account instantaneous Wi-Fi measurements and data from the INS navigation sensors.

In one embodiment, the server also includes means for filtering, with a Kalman filter 28, at least some inertial navigation data from the inertial system, and means for filtering, with the particle filter 30, the position result returned by “fingerprinting”, also integrating the inertial navigation data from the inertial measurement means, for example of the inertial system, of which at least some is corrected by the Kalman filter.

Finally, the invention relates to a system for locating a terminal 10 in an environment B equipped with a set of telecommunication terminal devices 12, 14, 16, 18 of a local wireless network.

The system includes at least one terminal 10 at least equipped with inertial measurement means, for example an inertial system delivering inertial navigation data and means for communication with a locating server, if necessary.

A locating server is therefore equipped with means for communication with the terminal 10.

A plurality of vectors, respectively associated with a plurality of different points of said environment B, are stored, in a preliminary step, in a reference database 24; each vector has, as components, values of powers received from the various terminal devices by a terminal positioned at the point associated with this vector.

The power received from at least some of the telecommunication terminal devices 12, 14, 16, 18 is measured from the terminal. An identification of the point at which the terminal is located is delivered as the position result.

This point is defined as that where the associated reference vector is closest, in the sense of Euclidean distance, to the vector formed by the powers measured from the terminal.

According to the invention, the system also includes filtering means using a Kalman filter 28 for filtering at least some of the inertial navigation data from the inertial system; and

filtering means using a particle filter 30 for filtering the position result, also integrating the inertial navigation data from the inertial system of which at least some is corrected by the Kalman filter.

Finally, the locating system is preferably such that the telecommunication terminal devices 12, 14, 16, 18 of a local wireless network are terminal devices of the Wi-Fi, Wimax, Bluetooth or Zigbee type.

In another embodiment, the invention can be implemented in the form of a computer program.

In this case, said program includes at least one instruction making it possible to determine the position at which the object is located according to:
at least one first signal received by first locating means of said locating system, wherein the “at least” first signal comes from at least one terminal device of a wireless network, and
at least one second signal provided by second locating means, different from said first means, of said locating system.

In addition, the invention can be implemented in the form of at least one programmable component capable of implementing at least one instruction for locating an object equipped with a locating system by determining the position at which the object is located, according to:
at least one first signal received by first locating means of said locating system, wherein the “at least” first signal comes from at least one terminal device of a wireless network, and
at least one second signal provided by second locating means, different from said first means, of said locating system.

The invention can advantageously be implemented in the following cases:
a visitor who does not know a site (office environment with a number of floors, or buildings) wants to meet a correspondent who is located in an office. When this visitor presents him/herself to the reception, he/she is given a communicating object (terminal), such as a PDA, for example, on which he/she can see a map of the site with two markers displayed on the screen. One of these markers represents the visitor's position in the environment considered, and the other is that of his/her correspondent (visited person). It is thus possible for the visitor to meet his/her correspondent without the latter having to come to get him/her at the reception;
in an exhibition lobby or a museum, where the visitor would know his/her position with respect to the museum, but services could also be offered according to his/her position, namely, if he/she is in a museum, a presentation of the works nearby,
in a hospital building, where it is necessary to find the location of objects with terminals such as, for example, specific equipment for operating areas.

1.-14. (canceled)

15. A method for locating a terminal in an environment equipped with a set of telecommunication terminal devices of a local wireless network, using a reference database previously stored with a plurality of vectors respectively associated with a plurality of different points of said environment, wherein each vector has, as components, values of powers received from the various terminal devices by a terminal positioned at the point associated with this vector, wherein the terminal includes inertial measurement means, which method includes the steps comprising:
measuring, from the terminal, the powers received from at least some of the telecommunication terminal devices;
delivering, as a position result, an identification of the point at which the terminal is located, which point is defined as that where the associated reference vector is closest to the vector formed by the powers measured from the terminal;
filtering the position result delivered, and taking into account inertial navigation data provided by the inertial measurement means; and
correcting an inertial drift of the inertial measurement means, taking into account a global trajectory of the terminal given by said means for filtering the position result delivered.

16. The method according to claim 15, including a step of filtering inertial navigation data consisting of filtering at least some of the inertial navigation data from the inertial measurement means.

17. A locating method according to claim 15, in which, in the step of filtering the delivered position result, a possible position of the terminal is modeled by a set of particles, with a presence probability being assigned to each of said particles.

18. The method according to claim 15, in which, in the step of filtering the delivered position result, parameters are modeled into probability densities so as to determine the presence probabilities to be assigned to the particles, with said parameters including at least one of the data items of the group comprising power data received, inertial navigation data and data relating to the environment of the terminal.

19. A locating method according to claim 17, in which, to determine the position of the terminal, a step of a priori determination of the position of the particles is provided, at least taking into account, for a particle, its last known position, a velocity of the particle and a data item representative of a state of the terminal, indicating whether or not it is moving, obtained on the basis of the data provided by the inertial measurement means.

20. The method according to claim 19, in which, to determine the position of the terminal, a step of a posteriori determination of the position of the particles is provided, taking into account new measurements of powers received from at least some of the telecommunication terminal devices.

21. A terminal configured so as to be located in an environment equipped with a set of telecommunication terminal devices of a local wireless network, with the terminal comprises:
inertial measurement means;
means for measuring, from the terminal, the powers received from at least some of the telecommunication terminal devices;
means for delivering, as a position result, an identification of the point at which the terminal is located, defined as that where an associated reference vector is closest to the vector formed by the powers measured from the terminal, with said reference vector being extracted from a reference database containing a plurality of reference vectors respectively associated with a plurality of different points of said environment, with each vector having, as components, values of power received from the various terminal devices by a terminal positioned at the point associated with this vector;
filtering means arranged to filter the delivered position result, also taking into account inertial navigation data from the inertial measurement means, and
correction means arranged to correct an inertial drift of the inertial measurement means, taking into account a global trajectory of the terminal given by said means for filtering the delivered position result.

22. The terminal according to claim 21, including means for communicating with a locating server.

23. The terminal according to claim 21, including means for filtering at least some of the inertial navigation data from the inertial measurement means.

24. The terminal according to claim 21, including means for storing said reference database.

25. A locating server configured to locate, in an environment equipped with a set of telecommunication terminal devices of a local wireless network, a terminal at least equipped with inertial measurement means, which server comprises:
means for communicating with the terminal;
means for storing, in a reference database, a plurality of vectors respectively associated with a plurality of different points of said environment, wherein each vector has, as components, values of powers received from the various terminal devices by a terminal positioned at the point associated with this vector;
means for delivering, as the position result, an identification of the point at which the terminal is located, which point is defined as that where the associated reference vector is closest, in the sense of Euclidean distance, to the vector formed by the powers measured from the terminal;
filtering means arranged to filter the delivered position result, also taking into account inertial navigation data from the inertial system; and
means for ordering a correction of an inertial drift of the inertial measurement means of the terminal, taking into account a global trajectory of the terminal given by said means for filtering the delivered position result.

26. A system for locating a terminal in an environment equipped with a set of telecommunication terminal devices of a local wireless network, which system comprises:
one terminal at least equipped with means for communication with a locating server, and an inertial system delivering inertial navigation data,
a locating server equipped with means for communication with the terminal, wherein:
a plurality of vectors, respectively associated with a plurality of different points of said environment, have previously been stored in a reference database; each vector has, as components, values of powers received from the various terminal devices by a terminal positioned at the point associated with this vector;
the power received from at least some of the telecommunication terminal devices is measured from the terminal;
an identification of the point at which the terminal is located is delivered as a position result, with this point being defined as that where an associated reference vector is closest, in the sense of Euclidean distance, to the vector formed by the powers measured from the terminal;
and wherein:
filtering means filter at least some of the inertial navigation data from the inertial system, and
correction means correct an inertial drift of the inertial measurement means of the terminal, taking into account a global trajectory of the terminal given by said means for filtering the delivered position result.

27. A computer program for a terminal, for locating said terminal in an environment equipped with a set of telecommunication terminal devices of a local wireless network, which program includes program instructions for ordering the execution by said terminal, when the program is executed by it, of steps at least consisting of:
measuring, from the terminal, the powers received from at least some of the telecommunication terminal devices;
delivering, as a position result, an identification of the point at which the terminal is located, which point is defined as that where the associated reference vector is closest to the vector formed by the powers measured from the terminal, wherein said reference vector is extracted from a reference database containing a plurality of vectors respectively associated with a plurality of different points of said environment, with each vector having, as components, values of powers received from the various terminal devices by a terminal positioned at the point associated with this vector;
filtering, with the assistance of filtering means, the delivered position result, also taking into account inertial navigation data provided by the inertial measurement means; and
correcting an inertial drift of the inertial measurement means, taking into account a global trajectory of the terminal given by said means for filtering the delivered position result.

28. A computer-readable program support on which the program according to claim 27 is saved.
